(19) United States
(12) Patent Application Publication
(10) Pub. No.: US 2008/0087334 A1
(43) Pub. Date: Apr. 17, 2008

(54) Device for conversion of valves to supervised valves

(75) Inventors: William J. Reilly, Langhorne, PA (US); Douglas P. Niebell, Walnutport, PA (US); Stephen R. Ide, Nazareth, PA (US)

Correspondence Address: SYNNESTVEDT & LECHNER, LLP, 1101 MARKET STREET, 26TH FLOOR, PHILADELPHIA, PA, 19107-2950, US

(73) Assignee: Victaulic Company, Easton, PA (US)

(21) Appl. No.: 11/541,824

(22) Filed: Oct. 2, 2006

(51) Int. Cl. F16K 37/00

(52) U.S. Cl. 137/554

(57) ABSTRACT

A device for converting a valve to a supervised valve is disclosed. The device includes a housing in which a coupling member is movably mounted. The coupling member is engageable with the actuating member of the valve when the device is mounted on the valve. A sensor is also mounted within the housing. A movable carriage is mounted on the coupling member. The carriage moves between different positions depending upon the state of the valve as open or closed. The carriage interacts with the sensor to produce a signal indicative of the state of the valve.

### FIELD OF THE INVENTION

This invention relates to fluid control valves known as “supervised valves” that provide a signal indicative of their state as open or closed.

### BACKGROUND OF THE INVENTION

Supervised valves are used in applications where knowledge of the valve's state as open or closed is required. Such valves are common in the nuclear industry for controlling the flow of cooling fluid to a reactor, in submarines to control flow of compressed air and water to and from the ballast tanks, in chemical processing plants, refineries and in safety systems such as fire suppression systems to control the flow of water to the sprinkler heads.

Supervised valves provide a signal, usually an electrical signal, that, when present, will illuminate a lamp on a control panel or provide input to a control unit remote from the valve. Using such a signal, an operator monitoring the system in which the valve is integrated is able to ascertain the state of the valve and, using additional information, determine whether or not the system is functioning properly or is in a desired state of readiness, and to take appropriate action if a malfunction or other undesired condition is manifest.

Supervised valves in the prior art are designed from their conception to have this supervisory capability, but it would be advantageous to be able to easily retrofit non-supervised valves and convert them into supervised valves. This capability would allow a greater choice of valve characteristics and types to be made available as either supervised or unsupervised valves. It would also enable valves that are already integrated into a system to be retrofitted to modify the system without the need to exchange the existing valves for supervised valves.

### SUMMARY OF THE INVENTION

The invention concerns a device mountable on a valve having a valve actuating member for opening and closing the valve. The device provides a signal indicative of the open or closed state of the valve. The device comprises a housing mountable on the valve. A coupling member is movably positioned within the housing. The coupling member is connectable to the actuating member. Motion of the coupling member moves the actuating member for opening and closing the valve. A sensor is positioned within the housing. The sensor is adapted to provide a signal indicative of the state of the valve. A movable carriage is positioned within the housing. The carriage is movable toward and away from the sensor in response to motion of the coupling member and the actuating member opening and closing the valve. The sensor provides the signal in response to the position of the carriage indicative of the state of the valve being open or closed.

In one embodiment, the actuating member comprises a first rotatable stem and the coupling member comprises a second rotatable stem engageable with the first rotatable stem. Preferably, the sensor comprises a proximity switch. The switch is configured so that when it is closed by interaction with the carriage, it passes an electrical current comprising the signal indicating that the valve is open.

In one embodiment, the carriage comprises a traveling washer threadedly mounted on the second rotatable stem. The traveling washer has a non-round shape and interfits within and engages the housing at a contact point which prevents its rotation. The traveling washer is movable axially along the second rotatable stem toward and away from the sensor through screw action in response to rotation of the a first rotatable stem opening and closing the valve.

The invention also includes a valve on which the aforementioned devices mounted, as well as a kit for converting existing valves to supervised valves.

The invention also includes a method of providing a signal indicative of the open or closed state of a valve. The valve has a valve actuating member for opening and closing the valve. The method comprises:
mounting a housing on the valve having a carriage therein movable in response to movement of the valve actuating member, the carriage being movable between a position indicative of the state of the valve being open and the valve being closed;
sensing the position of the carriage within the housing;
providing a signal in response to the position of the carriage, the position being indicative of the state of the valve being open or closed. In a preferred embodiment of the method, the signal is provided by closing a switch and allowing an electrical current to flow therethrough.

### BRIEF DESCRIPTION OF THE DRAWINGS

FIGS. 1, 2 and 3 are longitudinal sectional views illustrating the construction and operation of a valve converted to a supervised valve using the device according to the invention;

FIG. 4 is a cross-sectional view taken at line 4-4 of FIG. 1;

FIG. 5 is a cross-sectional view taken at line 5-5 of FIG. 1; and

FIGS. 6 and 7 are partial front views illustrating different embodiments of supervised valves according to the invention.

### DETAILED DESCRIPTION OF THE EMBODIMENTS

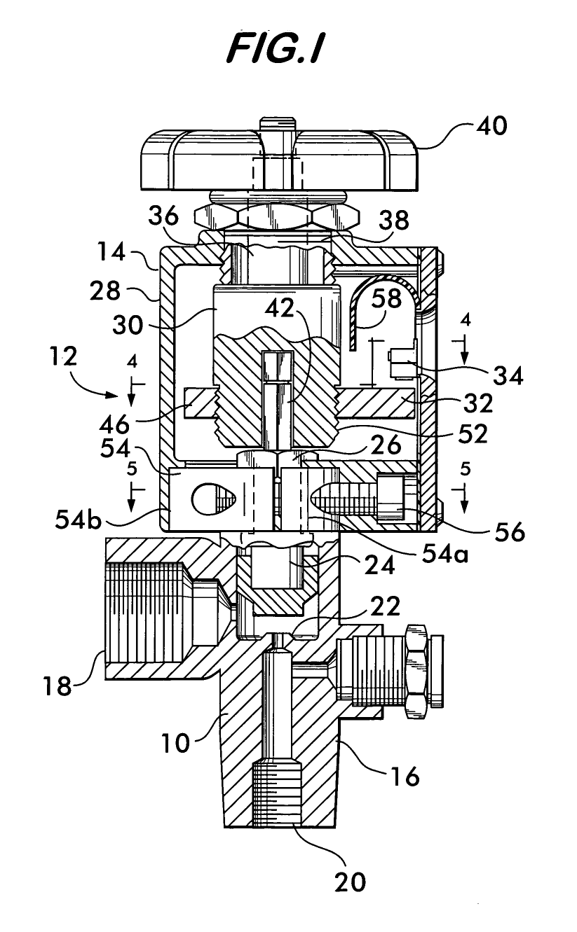

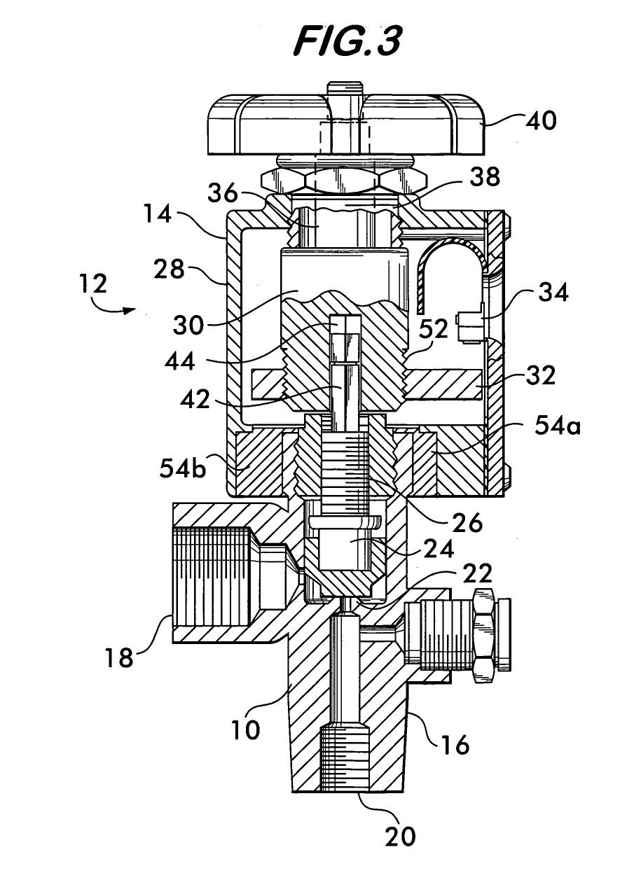

FIG. 1 shows a valve 10 converted to a supervised valve 12 using a device 14 according to the invention. Valve 10 comprises a valve body 16 having an inlet 18 and an outlet 20. A seat 22 is located within the valve body, the seat cooperating with a valve actuating member 24 to open and close the valve 10. In this example, the actuating member 24 comprises a rotatable valve stem 26 (best shown in FIG. 3) that advances toward or retreats away from the seat 22 upon rotation to respectively close and open the valve. It is understood that the type of valve shown is used for illustrative purposes only, as any type of valve, such as a butterfly valve, a ball valve or a gate valve may be converted to a supervised valve using a device according to the invention.

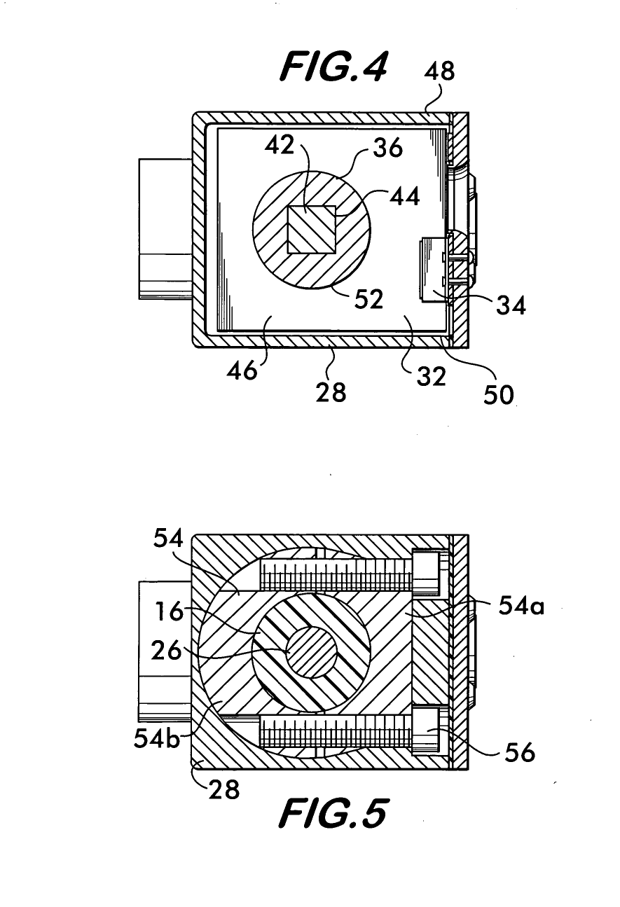

Device 14 comprises a housing 28 in which are contained a movable coupling member 30, a movable carriage 32 and a sensor 34. As best shown in FIG. 3, the coupling member 30 engages the actuating member 24 of valve 10 and is chosen to be appropriate for the particular type of valve. In the illustrated example, coupling member 30 comprises a second rotatable stem 36 that is rotatably mounted within the housing using a threaded gland 38. A portion of stem 36 projects outwardly from the housing 28 for attachment of a handle 40 for manual actuation of the valve. As shown in FIG. 4, the second stem 36 receives a square section 42 of the first valve stem 26 in a close fitting square socket 44 to ensure that the first valve stem 26 rotates with the second stem 36 when handle 40 is turned to open or close valve 10.

As shown in FIG. 1, movable carriage 32 preferably takes the form of a traveling washer 46 threadedly mounted on the second stem 36. As best illustrated in FIG. 4, the traveling washer 46 has a non-round shape, in this case rectangular, that interfits within the housing 28 so as to be engageable with the housing at one or more contact points. In this example, the contact points are located at the corners 48, 50 of the housing where the traveling washer would naturally contact the housing when the second stem 36 is rotated. Engagement between the traveling washer and the housing contact points 48 or 50 (depending upon the direction of rotation of stem 36) prevents rotation of the traveling washer. Because it is threadedly mounted on the second stem, however, the traveling washer advances or retreats axially along the second stem 36 toward or away from the valve 10 by screw action in response to rotation of the second stem. By choosing the pitch and handedness of the threads 52 between stem 36 and the traveling washer 46, both the direction of motion and the length of travel of the traveling washer may be coordinated with the motion of the valve stem opening and closing valve 10. In the example shown in FIG. 1, the threads 52 are designed so that the traveling washer moves in the same direction as the valve stem, moving upwardly away from the valve when the valve is being opened and downwardly toward the valve when the valve is being closed. By choosing threads 52 of opposite hand, the direction of motion of the traveling washer may be reversed, so that it moves downwardly upon opening of the valve and upwardly upon valve closing. The pitch of the threads controls how far the washer moves per unit rotation of the second stem and is used to coordinate the motion of the traveling washer with the sensor 34.

Traveling washer 46 cooperates with the sensor 34, positioned within the housing 28, to generate a signal indicative of the state of valve 10. The traveling washer, sensor and valve may be coordinated in any number of ways, for example, to generate a signal when the valve is opened or generate a signal when the valve is closed, or if multiple sensors are used, to generate a first signal indicating that the valve is open and a second signal indicating that the valve is closed.

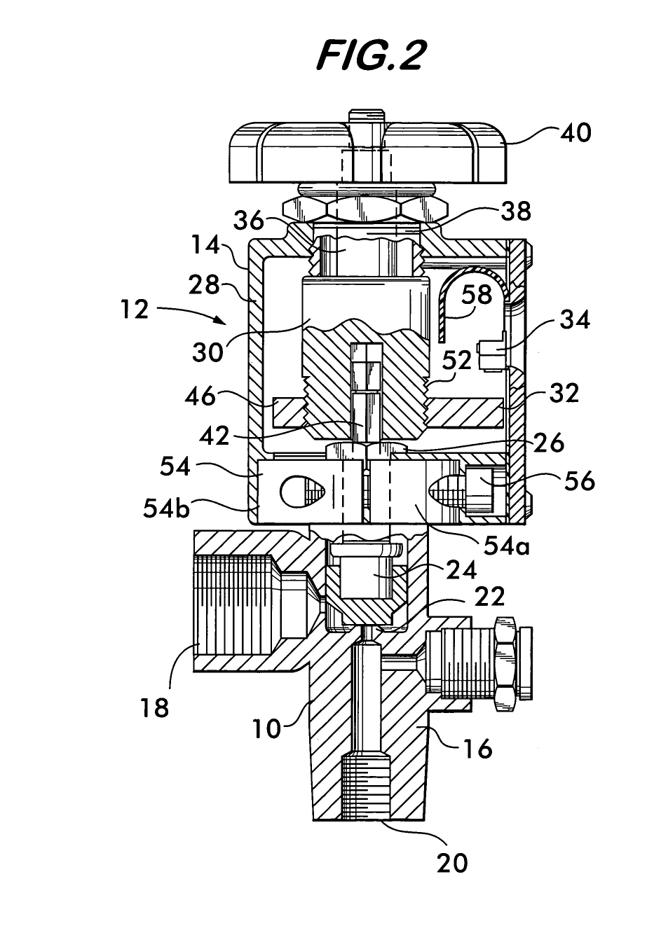

In the example shown, the sensor 34 comprises a proximity switch fixedly mounted to the interior of housing 28 and positioned so that it senses the presence or absence of the traveling washer. When, as shown in FIG. 1, the valve 10 is open and the traveling washer 46 has moved upwardly and is in close proximity to the switch 34, the switch closes and allows electrical current to flow, providing the signal indicating that the valve is open. This signal could be used, for example, to light a lamp on a control panel, or as input to a microprocessor in an automated control system. FIG. 2 shows the valve 10 in a closed state, the traveling washer 46 having moved away from the switch 34 upon rotation of the stem 36. The switch opens in response to the absence of the traveling washer, halting the flow of electrical current indicating that the valve is closed.

The sensor 34 may alternately be a contact switch, an optical or acoustic sensor or other device that can sense the presence or absence of the traveling washer. The sensor could also be configured to close a switch when the traveling washer is near, or open the switch when it is near. Furthermore, by simply repositioning the sensor on one side or the other of the traveling washer, the state indicated by device 14 can be reversed. The sensor may also be affixed to the traveling washer itself and sense the proximity of a portion of the housing 28 that is fixed relatively to the traveling washer.

Device 14 also includes a mounting element, preferably in the form of a split ring 54 as shown in FIGS. 1 and 5. A portion 54a of the split ring is attached to the housing 28 by fasteners 56, and a second portion 54b of the split ring is attached to the first portion by the same fasteners. The valve body 16 is received between the split ring portions 54a and 54b and when the fasteners are tightened the housing 28 is thereby fixed to the valve body 16, mounting the device 14 on the valve 10 and converting it to a supervised valve 12. The installation is completed by connecting the leads 58 from the sensor 34 to an appropriate circuit so that the signal generated indicative of the valve state may be used as desired in the system in which the valve is integrated.

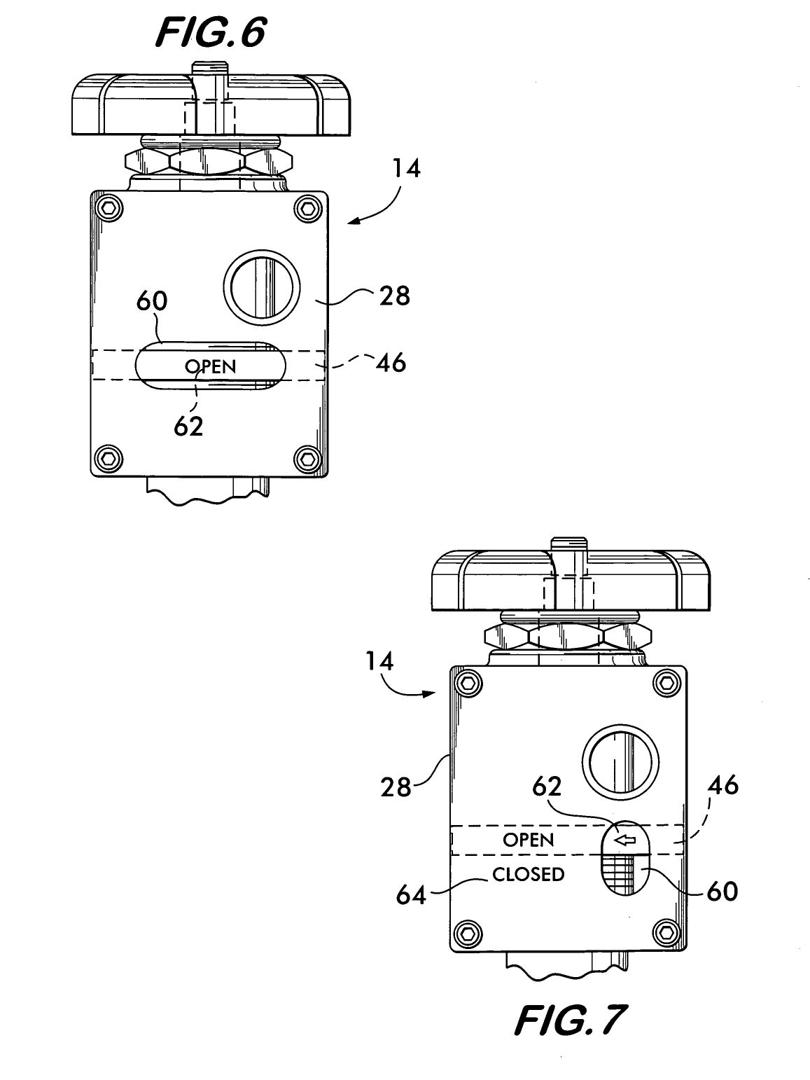

In addition to providing an electric signal indicative of the valve status, the device 14 according to the invention may also provide a visual indication of the valve status. This is achieved as illustrated in FIGS. 6 and 7, wherein the housing 28 has a window 60 through which a portion of the traveling washer 46 or other form of moving carriage used is visible. As shown in FIG. 6, the presence of the washer 46 in the window 60 may signal that the valve is open as indicated by indicia 62. Alternately, and depending upon the internal arrangement of the components within housing 28 as described above, a visible carriage or washer 46 may also indicate a closed valve, the indicia 62 being changed appropriately. In the example shown in FIG. 7, the indicia 62 on the traveling washer 46 takes the form of an arrow and acts as a pointer, cooperating with additional indicia 64 on the outside of housing 28 to indicate the valve status.

Valve conversion devices provided as kits according to the invention allow valves of any type to be adapted for use as a supervised valve, thereby advantageously expanding the spectrum of valves conveniently useable as supervised valves.

What is claimed is:

1. A device mountable on a valve having a valve actuating member for opening and closing said valve, said device providing a signal indicative of an open or closed state of said valve, said device comprising:
a housing mountable on said valve;
a coupling member movably positioned within said housing, said coupling member being connectable to said actuating member, motion of said coupling member moving said actuating member for opening and closing said valve;
a sensor positioned within said housing, said sensor being adapted to provide a signal indicative of said state of said valve; and
a movable carriage positioned within said housing, said carriage being movable toward and away from said sensor in response to motion of said coupling member and said actuating member opening and closing said valve, said sensor providing said signal in response to the position of said carriage indicative of the state of said valve being open or closed.

2. A device according to claim 1, wherein said actuating member comprises a first rotatable stem and said coupling member comprises a second rotatable stem engageable with said first rotatable stem.

3. A device according to claim 1, wherein said sensor comprises a switch.

4. A device according to claim 3, wherein said switch comprises a proximity switch.

5. A device according to claim 3, wherein said switch is configured so that when said switch is closed by interaction with said carriage, said switch passes an electrical current comprising said signal indicating that said valve is open.

6. A device according to claim 2, wherein said carriage comprises a traveling washer threadedly mounted on said second rotatable stem, said traveling washer having a non-round shape interfitting within and engaging said housing at a contact point thereon which prevents its rotation, said traveling washer being movable axially along said second rotatable stem toward and away from said sensor through screw action in response to rotation of said first rotatable stem opening and closing said valve.

7. A device according to claim 2, further comprising a window positioned within said housing such that a portion of said carriage is visible therethrough when said carriage occupies a predetermined position relative to said sensor, the position of said carriage in said window providing a visual indication of the state of said valve being open or closed.

8. A supervised valve providing a signal indicative of the open or closed state of said valve, said valve comprising:
a valve actuating member movable for opening and closing said valve;
a housing mounted on said valve;
a coupling member movably positioned within said housing, said coupling member being connected to said actuating member, motion of said coupling member moving said actuating member for opening and closing said valve;
a sensor positioned within said housing, said sensor being adapted to provide said signal indicative of said state of said valve; and
a movable carriage positioned within said housing, said carriage being movable toward and away from said sensor in response to motion of said coupling member and said actuating member opening and closing said valve, said sensor providing said signal in response to the position of said carriage indicative of the state of said valve being open or closed.

9. A device according to claim 8, wherein said actuating member comprises a first rotatable stem and said coupling member comprises a second rotatable stem, said second rotatable stem engaging said first rotatable stem.

10. A device according to claim 8, wherein said sensor comprises a switch.

11. A device according to claim 10, wherein said switch comprises a proximity switch.

12. A device according to claim 10, wherein said switch is configured so that when said switch is closed by interaction with said carriage, said switch passes an electrical current comprising said signal indicating that said valve is open.

13. A device according to claim 9, wherein said carriage comprises a traveling washer threadedly mounted on said second rotatable stem, said traveling washer engaging said housing which prevents its rotation, said traveling washer being movable axially along said second rotatable stem toward and away from said sensor in response to rotation of said rotatable stems opening and closing said valve.

14. A device according to claim 13, further comprising a window positioned within said housing such that a portion of said traveling washer is visible therethrough when said traveling washer occupies a predetermined position relative to said sensor, the position of said traveling washer in said window providing a visual indication of the state of said valve being open or closed.

15. A device mountable on a valve having a rotatable valve actuating member for opening and closing said valve, said device providing a signal indicative of the open or closed state of said valve, said device comprising:
a housing mountable on said valve;
a rotatable stem positioned within said housing, said rotatable stem being connectable to said actuating member, rotational motion of said rotatable stem rotatable said actuating member for opening and closing said valve;
a switch positioned within said housing, said switch being adapted to provide a signal indicative of said state of said valve; and
a traveling washer threadedly mounted on said rotatable stem, said traveling washer having a non-round shape interfitting within and engaging said housing at a contact point thereon which prevents its rotation, said traveling washer being movable axially along said rotatable stem toward and away from said sensor through screw action in response to rotation of said actuating member opening and closing said valve.

16. A device according to claim 15, wherein said switch comprises a proximity switch.

17. A device according to claim 15, wherein said switch is configured so that when said switch is closed by interaction with said traveling washer, said switch passes an electrical current comprising said signal indicating that said valve is open.

18. A kit for a valve having a rotatable valve actuating member for opening and closing said valve, said kit for adapting said valve to provide a signal indicative of the open or closed state of said valve, said kit comprising:
a housing;
a split collar affixed to said housing and mountable on said valve for attaching said housing thereto;
a rotatable stem positioned within said housing, said rotatable stem being connectable to said actuating member, rotational motion of said rotatable stem rotatable said actuating member for opening and closing said valve;
a switch positioned within said housing, said switch being adapted to provide a signal indicative of said state of said valve; and
a traveling washer threadedly mounted on said rotatable stem, said traveling washer engaging said housing which prevents its rotation, said traveling washer being movable toward and away from said sensor in response to rotational motion of said rotatable stem and said actuating member opening and closing said valve, said switch providing said signal in response to the position of said traveling washer indicative of the state of said valve being open or closed.

19. A method of providing a signal indicative of the open or closed state of a valve, said valve having a valve actuating member for opening and closing said valve, said method comprising:
mounting a housing on said valve having a carriage therein movable in response to movement of said valve actuating member, said carriage being movable between a position indicative of the state of said valve being open and said valve being closed;
sensing the position of said carriage within said housing; and
providing a signal in response to the position of said carriage, said position being indicative of the state of said valve being open or closed.

20. A method according to claim 19, wherein said signal is provided by closing a switch and allowing an electrical current to flow therethrough.
